(19) United States
(12) Patent Application Publication
(10) Pub. No.: US 2011/0214691 A1
(43) Pub. Date: Sep. 8, 2011

(54) METHOD AND APPARATUS FOR WASHING SUBSTRATES

(75) Inventors: Toshihide MIYAJIMA, Kamisato (JP); Brian RATTRAY, Kamisato (JP)

(73) Assignee: HITACHI HIGH-TECHNOLOGIES CORPORATION, Tokyo (JP)

(21) Appl. No.: 13/027,876

(22) Filed: Feb. 15, 2011

(30) Foreign Application Priority Data
Mar. 3, 2010 (JP) 2010-046508

(51) Int. Cl. B08B 7/00; B08B 3/00

(52) U.S. Cl. 134/6; 134/94.1

(57) ABSTRACT

An apparatus for washing a substrate includes a scrub washing unit for washing both surfaces of a substrate, which are scrubbed by a rotating brush while supplying pure water to both surfaces of the substrate, a rinse unit for washing the surfaces of the substrate which have been washed by the scrub washing unit using the pure water, and a dry unit for drying the surfaces of the substrate which have been washed by the rinse unit. The scrub washing unit includes an ultrasonic application unit for applying ultrasonic waves to pure water supplied to the both surfaces of the substrate, which are scrubbed by the rotating brush while supplying the pure water to which the ultrasonic wave has been applied by the ultrasonic application unit to the both surfaces of the substrate.

### BACKGROUND

The present invention relates to a method and an apparatus for washing substrates, which washes a magnetic disc, an optical disc, and a disc substrate of a semiconductor wafer, and dries the washed substrate.

An example of a disc washing apparatus will be described as related art. Japanese Unexamined Patent Publication No. Hei 5-290373 discloses a disc washing apparatus provided with a first ultrasonic washing station, a brush washing station and a second ultrasonic washing station for washing a plurality of discs simultaneously as an exemplary generally employed apparatus for washing the magnetic disc substrate.

Japanese Unexamined Patent Publication No. 2001-96245 discloses a washing apparatus provided with a washing unit which includes a shower bath, a chemical bath, an ultrasonic bath and a pure water bath.

Japanese Unexamined Patent Publication No. Hei 6-5577 discloses a substrate washing apparatus which washes the substrates one by one using a washing brush which rotates within washing solvent in an overflow bath while activating ultrasonic waves oscillated by an ultrasonic wave oscillator.

U.S. Pat. No. 6,810,548 discloses a washing apparatus which washes one surface (upper surface) of the substrate using a roll brush while supplying the washing solvent from a shower nozzle. The washing apparatus washes the opposite surface (back surface) of the substrate with ultrasonic waves by injecting the washing solvent to which the ultrasonic oscillation has been applied from the ultrasonic nozzle. The washing solvent to which the ultrasonic oscillation has been applied is fed to the lower surface of the substrate so as to propagate the ultrasonic wave to the upper surface of the substrate, which will be subjected to the ultrasonic washing.

Furthermore, Japanese Unexamined Patent Publication No. 2007-207377 discloses a disc washing system configured to have shower washing baths each provided among a disc loader, an acid chemical ultrasonic washing bath, an alkaline chemical washing bath, a pure water bath, and a dry room.

Each of the washing apparatuses disclosed in Japanese Unexamined Patent Publication Nos. 5-290373 and 2001-96245 has a problem that a large quantity of pure water is consumed for conducting the ultrasonic washing and brush washing separately, and entire size of the washing apparatus is enlarged, resulting in a large floor area (footprint) occupied by the apparatus.

Japanese Unexamined Patent Publication No. 6-5577 discloses that both surfaces of each substrate on the carrier roller, having one surface in contact with the carrier roller and the opposite surface (upper surface) are washed with a brush in the washing solvent to which the ultrasonic wave has been applied. As the transversely positioned substrate is cleaned by washing one surface and the other, respectively, the space for washing both surfaces of the substrate has to be enlarged. As the substrate is washed one by one, a large quantity of pure water is required.

The U.S. Pat. No. 6,810,548 discloses that the substrate is cleaned by washing one surface with the brush while supplying the washing solvent from the shower nozzle, and the opposite surface with ultrasonic wave. The space for washing both surfaces of the substrate has to be enlarged. As the substrates are washed one by one, a large quantity of pure water is required.

Japanese Unexamined Patent Publication No. 2007-207377 discloses the disc washing system in which the shower washing bath, the acid chemical ultrasonic bath, the alkaline chemical ultrasonic bath, the pure water bath, and the dry room are arranged. The system may be structured to replace the shower washing bath with the brush washing bath. Alternatively, both the shower washing bath and the brush washing bath may be used. However, the ultrasonic washing conducted in the shower washing bath or the brush washing bath is not disclosed.

### SUMMARY

The present invention provides an apparatus and a method for washing both surfaces of the substrate such as a disc while reducing a quantity of pure water required for washing, and making the apparatus compact to reduce the footprint occupied thereby so as to suppress power consumption.

According to the present invention, in a scrub washing unit of the washing apparatus for washing both surfaces of the substrate, the generally employed pure water nozzle is replaced with the ultrasonic spot nozzle to allow the ultrasonic washing to be performed simultaneously with the scrub washing, thus reducing the number of the ultrasonic washing baths.

The present invention provides a washing apparatus including a scrub washing unit for washing both surfaces of a substrate, which are scrubbed by a rotating brush while supplying pure water to the both surfaces of the substrate, a rinse unit for washing the surfaces of the substrate which have been washed by the scrub washing unit using the pure water, and a dry unit for drying the surfaces of the substrate which have been washed by the rinse unit. The scrub washing unit includes an ultrasonic application unit for applying ultrasonic waves to the pure water supplied to the both surfaces of the substrate, which are scrubbed by the rotating brush while supplying the pure water to which the ultrasonic wave has been applied by the ultrasonic application unit to the both surfaces of the substrate.

The present invention further provides a method for washing comprising the steps of washing both surfaces of a substrate to be scrubbed with a brush which is rotated while supplying pure water to the both surfaces of the substrate, rinsing the surfaces of the substrate which have been washed using the brush, and drying the surfaces of the substrate which have been rinsed. In the step of washing by scrubbing with the brush, the both surfaces of the substrate are scrubbed and washed by the rotating brush while supplying the pure water to which an ultrasonic wave has been applied to the both surfaces of the substrate.

The ultrasonic washing bath and the brush washing bath are integrated to make the apparatus compact, thus reducing the footprint and consumption of pure water and power. The resulting cost for running the apparatus may be reduced, and the throughput for washing may also be improved.

These features and advantages of the invention will be apparent from the following more particular description of preferred embodiments of the invention, as illustrated in the accompanying drawings.

### BRIEF DESCRIPTION OF THE DRAWINGS

FIG. 1A is a block diagram illustrating a general structure of a washing apparatus;

FIG. 1B is a sectional view of a loader unit and a carrier unit;

FIG. 2 is a flowchart which represents a washing process;

FIG. 3 is a perspective view which represents a relationship between a brush and a guide roller of a scrub washing unit, and a substrate;

FIG. 4 is a front view which represents a relationship between the brush and the guide roller of the scrub washing unit, and the substrate; and

FIG. 5 is a side sectional view which represents a relationship between the brush and the guide roller of the scrub washing unit, and the substrate.

### DESCRIPTION OF THE PREFERRED EMBODIMENTS

An example of the present invention applied to a disc washing apparatus for washing a magnetic disc will be described referring to the drawings.

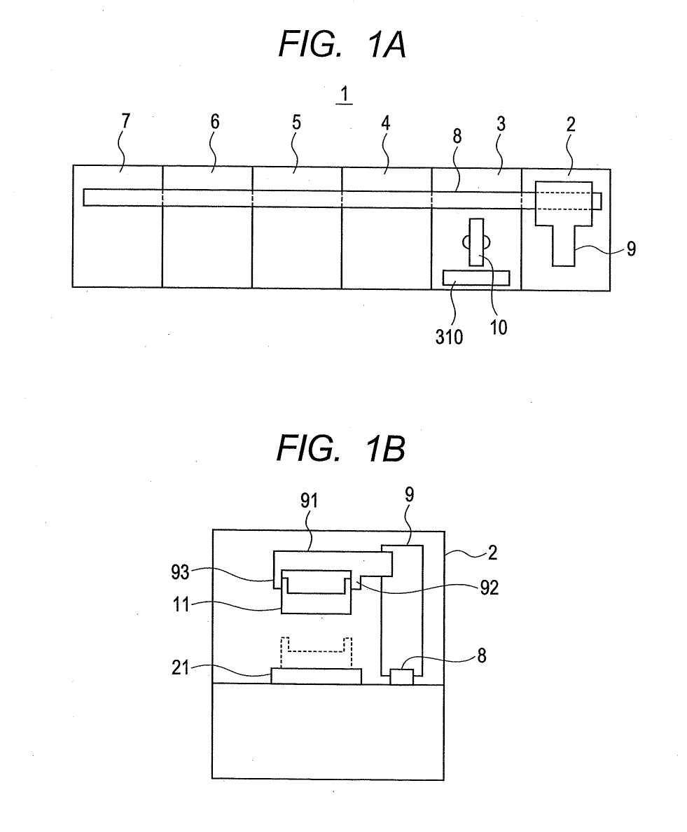

FIG. 1A illustrates a structure of a disc washing apparatus 1 as an example of the present invention.

The disc washing apparatus 1 includes a loader unit 2, a scrub washing unit 3, a quick-damp-rinse (QDR) unit 4, a rinse unit 5, a dry unit 6, an unloader unit 7, and a carrier unit 9 which moves and carries a disc cassette 11 loaded with a plurality of substrates between the respective units along a rail 8.

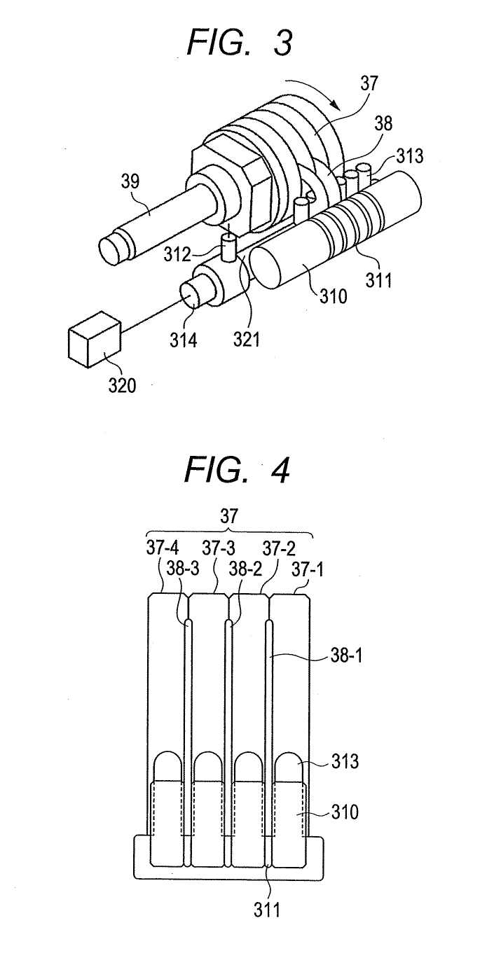

The apparatus is further provided with a handling unit 10 for taking out each one of the substrates which have been carried by the carrier unit 9 from the disc cassette 11 so as to be set on a guide roller 310 (see FIG. 3), and further taking out the washed substrates from the guide roller one by one so as to be returned to the disc cassette.

The carrier unit 9 moves from the substrate loader unit 2 to the scrub washing unit 3, the quick-damp-rinse (QDR) unit 4, the rinse unit 5, the dry unit 6, and the unloader unit 7 along the rail 8. The carrier unit 9 which moves between the respective units as described above along the rail 8 may be replaced with a plurality of fixed robots (for example, scalar type robot) that are fixed corresponding to the respective units.

FIG. 1B is a cross sectional view of the loader unit 2 when the carrier unit 9 is positioned therein. The carrier unit 9 is guided by the rail 8, and driven by a drive unit (not shown) to move along the rail 8 in a vertical direction with respect to the drawing. An arm portion 91 of the carrier unit 9 is moveable up and down by a drive mechanism (not shown) along the carrier unit 9. The carrier arm portion 91 is provided with a pair of chucks 92, 93 which can be opened and closed for holding and releasing the cassette 11, respectively.

In the state where the cassette 11 loaded with the substrates is supplied from outside onto a table 21 in the loader unit 2, the arm portion 91 of the carrier unit 9 is driven to move down by the not-shown drive unit while opening the chucks 92 and 93. Then the chucks 92 and 93 are closed at a lower end position to hold the cassette 11. In the state where the cassette 11 is held by the chucks 92 and 93, the arm portion 91 is driven by the drive unit (not shown) to move up to a predetermined height. FIG. 1B shows the state where the arm portion 91 has moved up to the predetermined height.

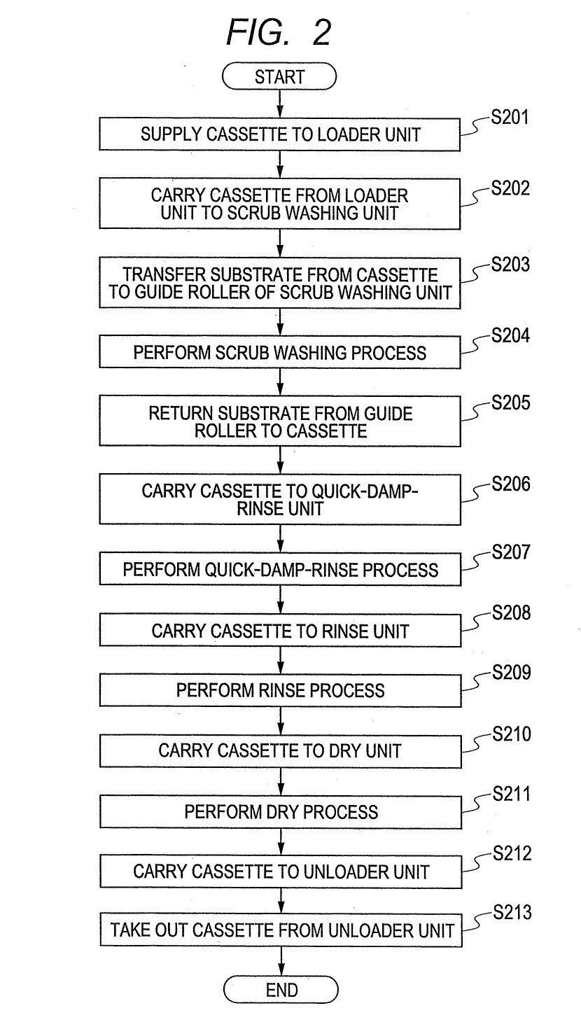

The process for washing the substrate using the washing apparatus shown in FIG. 1A will be described referring to FIG. 2.

The disc cassette 11 which stores a plurality of the substrates is supplied from outside to the loader unit 2 in step S201. The disc cassette 11 thus supplied is moved by the carrier unit 9 along the rail 8 so as to be carried to the scrub washing unit 3 in step S202.

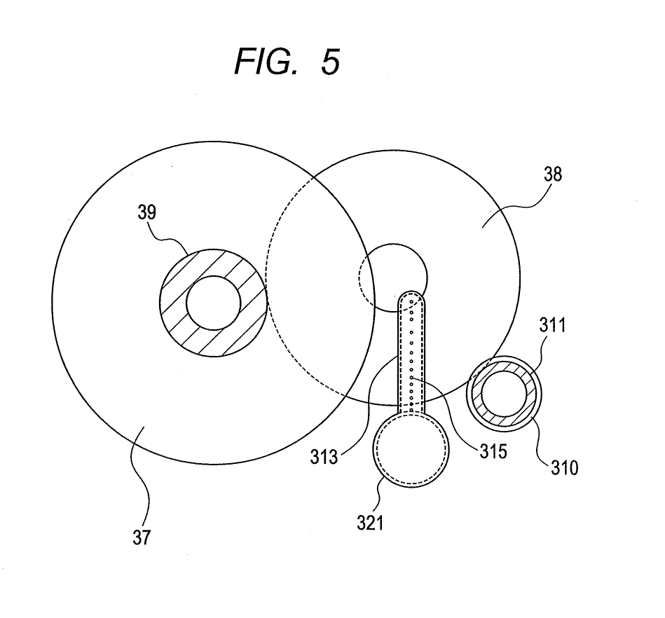

In the scrub washing unit 3, the handling unit 10 takes a substrate 38 from the disc cassette 11, and loads the substrate 38 in the guide roller 310 of the scrub washing unit 3 in step S203. A brush 37 is provided opposite the guide roller 310. As shown in FIG. 5, the substrate 38 is supported by a center shaft 39 of the brush 37 and the guide roller 310 while being sandwiched between the brushes 37. In step S204, each of the plurality of the substrates 38 which are set on the guide roller 310 and supported at the center shaft 39 of the brush 37 and the guide roller 310 has its both surfaces scrubbed with the brushes 37 so that both surfaces of each of the plurality of the substrates 38 are subjected to scrub washing simultaneously while being showered with pure water to which the ultrasonic wave has been applied.

The substrate 38 which has been scrub washed is returned to the disc cassette 11 again in step S205, and is further carried by the carrier unit 9 to the quick-damp-rinse unit 4 along the rail 8 in step S206.

The quick-damp-rinse unit 4 rinses the surface of the substrate 38 loaded in the disc cassette 11 while showering the substrate 38 with rinse solvent stored in a rinse solvent bath (not shown) in step S207.

The disc cassette 11 which stores the substrate 38 that has been washed in the quick-damp-rinse unit 4 is carried to the rinse unit 5 by the carrier unit 9 along the rail 8 in step S208.

In step S209, the substrate washed in the quick-damp-rinse unit 4 and loaded in the disc cassette 11 is submerged in the bath filled with pure water of the rinse unit 5 for rinsing.

The disc cassette 11 which stores the substrate 38 that has been rinsed in the rinse unit 5 is carried to the dry unit 6 by the carrier unit 9 in step S210 so that the substrate is dried by evaporating pure water adhered to the substrate surface in step S211. The cassette 11 which stores the dried substrate 38 is taken out from the dry unit 6 by the carrier unit 9 and carried to the unloader unit 7 in step S212. It is then taken from the unloader unit 7 outside the washing apparatus 1 in step S213.

Of the series of process steps as described above, the scrub washing process performed in the scrub washing unit 3 will be described in detail referring to FIGS. 3 to 5.

FIG. 3 is a perspective view of the scrub washing unit 3. FIG. 4 is a front view of the brush showing that the plurality of the substrates 38 sandwiched between the brushes 37 are supported at the center shaft 39 of the brush and the guide roller 310. FIG. 5 is a side view of the structure shown in FIG. 4.

The plurality of the substrates 38 stored and supplied in the disc cassette 11 are sequentially taken out from the disc cassette 11 by the handling unit 10, and each of the substrates 38 is sandwiched between the brushes 37 at the position supported at a groove portion 311 of the guide roller 310 and the center shaft 39 of the brush 37 in the scrub washing unit 3.

Upon rotation of the center shaft 39 in the aforementioned state driven by a motor not shown in FIG. 3, the brush 37 rotates to scrub both surfaces of the substrate 38. The substrate 38 rotates at the speed lower than that of the brush 37. Meanwhile, pure water is supplied from a water inlet 312 formed around the end portion of the water supply tube 321 so as to be injected from a large number of jet ports 315 formed in plural pipes 313 attached to the water supply tube 321. At this time, the ultrasonic wave oscillated by an ultrasonic oscillator 320 is introduced to inside the water supply tube 321 from the ultrasonic inlet 314 formed at the end portion of the water supply tube 321 so that the ultrasonic wave is applied to pure water that has been supplied from the water inlet 312 to inside the water supply tube 321.

The pure water to which the ultrasonic wave has been applied is injected from the large number of jet ports 315 formed in the plural pipes 313 attached to the water supply tube 321 to shower both surfaces of the substrate 38 while being scrubbed with the brush 37. In the aforementioned state, a pure water layer with a thickness ranging from 1 to 2 mm is formed between a part of both surfaces of the substrate 38 where the pure water to which the ultrasonic wave has been applied is supplied and the brush 37. The pure water layer formed between the substrate 38 and the brush 37 allows both surfaces of the substrate 38 to be subjected to the ultrasonic pure water washing. Meanwhile, at the point away from the jet port 315, the effect of the ultrasonic wave applied to pure water is weakened. Accordingly, the pure water layer is not formed between the substrate 38 and the brush 37 at the point away from the jet port 315. The brush washing is performed by bringing the rotating brush 37 into contact with both surfaces of the substrate 38.

Thereby, by continuing the scrub washing for a preset time period while supplying pure water to which the ultrasonic wave has been applied, both of the ultrasonic pure water washing and the brush washing are applied to the entire surfaces of the corresponding sides of the substrate 38.

It means that foreign matters adhered to the surface of the substrate 38 are removed by the scrub washing from both surfaces of each of the plurality of substrates 38 by rotating the plurality of the brushes 37 while supplying pure water to which the ultrasonic wave has been applied. This allows the single apparatus to perform both the brush washing and the ultrasonic pure water washing at the same time which have been conventionally performed by using different apparatuses. Thus, the present invention allows to omit the conventionally employed apparatus for the ultrasonic pure water washing process. As a result, the floor area (footprint) occupied by the washing apparatus as a whole may be reduced.

The quantity of pure water used for the ultrasonic brush washing process may be the same as that of pure water for the conventionally employed brush washing process. This makes it possible to reduce as much pure water as used for the conventionally employed ultrasonic pure water washing.

As the conventionally employed brush washing process and the ultrasonic washing process are simultaneously performed, the power consumption may also be reduced.

In the aforementioned example, the substrate is subjected to the scrub washing process in the scrub washing unit 3, and thereafter, it is further subjected to the quick-damp-rinse process in the quick-damp-rinse unit 4. However, as disclosed in the U.S. Pat. No. 6,810,548, the chemical washing bath used for subjecting the surface of the substrate 38 to the ultrasonic washing process with acid or alkaline chemical may be inserted between the scrub washing unit 3 and the quick-damp-rinse unit 4. The invention may be embodied in other specific forms without departing from the spirit or essential characteristics thereof. The present embodiment is therefore to be considered in all respects as illustrative and not restrictive, the scope of the invention being indicated by the appended claims, rather than by the foregoing description, and all changes which come within the meaning and range of equivalency of the claims are therefore intended to be embraced therein.

What is claimed is:

1. A washing apparatus comprising:
a scrub washing unit for washing both surfaces of a substrate, which are scrubbed by a rotating brush while supplying pure water to the both surfaces of the substrate;
a rinse unit for washing the surfaces of the substrate which have been washed by the scrub washing unit using pure water; and
a dry unit for drying the surfaces of the substrate which have been washed by the rinse unit,
wherein the scrub washing unit includes an ultrasonic application unit for applying ultrasonic waves to the pure water supplied to the both surfaces of the substrate, which are scrubbed by the rotating brush while supplying the pure water to which the ultrasonic wave has been applied by the ultrasonic application unit to the both surfaces of the substrate.

2. The washing apparatus according to claim 1, wherein the substrate is supported at a center shaft of the rotating brush and a guide roller in the scrub washing unit while supplying the pure water to which the ultrasonic wave has been applied from plural jet ports formed in plural pipes attached to a water supply tube.

3. The washing apparatus according to claim 1, wherein a plurality of the substrates are supported at the center shaft of the rotating brush and the guide roller in the scrub washing unit, and the pure water to which the ultrasonic wave has been applied is supplied from plural jet ports formed in plural pipes attached to a water supply tube to the both surfaces of each of the plurality of substrates.

4. The washing apparatus according to claim 1, further comprising a loader unit for supplying the externally fed substrate to the scrub washing unit, and an unloader unit for taking the substrate dried in the dry unit out of the apparatus.

5. The washing apparatus according to claim 1, wherein the rinse unit for washing the surfaces of the substrate which have been washed in the scrub washing unit using the pure water includes a quick-damp-rinse bath provided with a rinse solvent bath and a washing bath for showering the substrate with rinse solvent stored in the rinse solvent bath within the washing bath for rinsing the surfaces of the substrate, and a rinse bath for washing the substrate which has been subjected to a process in the quick-damp-rinse bath using the pure water.

6. A method for washing comprising the steps of:
washing both surfaces of a substrate to be scrubbed with a brush which is rotated while supplying pure water to the both surfaces of the substrate;
rinsing the surfaces of the substrate which have been washed using the brush; and
drying the surfaces of the substrate which have been rinsed,
wherein in the step of washing by scrubbing with the brush, the both surfaces of the substrate are scrubbed and washed by the rotating brush while supplying the pure water to which an ultrasonic wave has been applied to the both surfaces of the substrate.

7. The method for washing according to claim 6, wherein in the step of washing the both surfaces of the substrate by scrubbing, the substrate is supported at a center shaft of the brush and a guide roller, and the both surfaces of the substrate are scrubbed and washed by the rotating brush while supplying the pure water to which the ultrasonic wave has been applied from plural jet ports formed in plural pipes attached to a water supply tube to the both surfaces of the substrate.

8. The method for washing according to claim 6, wherein in the step of washing the both surfaces of the substrate by scrubbing, a plurality of the substrates are supported at a center shaft of the brush and a guide roller, and the both surfaces of each of the plurality of substrates are scrubbed and washed by the rotating brush while supplying the pure water to which the ultrasonic wave has been applied from plural jet ports formed in plural pipes attached to a water supply tube to the both surfaces of each of the plurality of substrates.

9. The method for washing according to claim 6, wherein in the step of rinsing the surfaces of the substrate with the pure water, a quick-damp-rinse process is performed for rinsing the surfaces of the substrate by showering the substrate with rinse solvent stored in a rinse solvent bath, and a rinse process is performed for washing the substrate which has been subjected to the quick-damp-rinse process with the pure water.
